(19) United States
(12) Patent Application Publication
(10) Pub. No.: US 2008/0315051 A1
(43) Pub. Date: Dec. 25, 2008

(54) Adaptable mobile phone rack

(76) Inventor: David Cutangco Barrameda, JR., Magarao (Metro Naga City) (PH)

Correspondence Address: DAVID C. BARRAMEDA, JR.;CAMARINES SUR, 82 BARANGAY STO., TOMAS, MAGARAO,, CAMARINES SUR, 4403, PH

(21) Appl. No.: 11/820,232

(22) Filed: Jun. 20, 2007

(51) Int. Cl. B60R 11/02

(52) U.S. Cl. 248/223.21

(57) ABSTRACT

A mobile phone rack having adaptable means for it may be hanged in screw heads or in a hanger adaptor or, may stand or placed upright in a bag, pocket and the likes while the mobile phone is safe and available for immediate grip and use or, may be adapted with plugs and their wires unobstructed. The rack having adjustable means wherein a frame with a rubber cap sidewall to cushion the mobile phone back wall is perpendicular to forearm rods sleeved with tapered rubber tubes which are cushioning and diverging across edges to primarily confine the mobile phone, the forearms are extending down to spaced concaves a safety net and a shield and extending to transverse legs with rubber tubes to cushion and contain the bottoms. Fingers may move, easily, the forearms and the tapered tubes may be pushed or pulled, easily, for adjustment in width and thickness, respectively.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to racks, one of its purpose is similar to the holders of mobile phone, more specifically to racks being adaptable and having a pocket adjoining an opening means adjustable by hand, easier, appropriate for various sizes of mobile phone. The holders of mobile phone are of lesser adaptability, examples of such are disclosed in U.S. Pat. Nos. 5,457,745; 5,187,744 and 5,222,132.

### BRIEF SUMMARY OF THE INVENTION

According to the present invention the mobile phone racks are supported in such a fashion to be of greater adaptability, adaptability means this invention having a folding stand or, may be placed upright in a bag, pocket or the likes while the mobile phone is secured and accessible for immediate grip and use or, may be hanged in screw heads or, may be hanged in a hanger adaptor, the mobile phone is cushioned by and adapted only on rubber components and its bottom may be adapted with plugs and wires unobstructed. In another embodiment an access by fingers to the keypad is provided. The pocket means is easily adjustable to fit various mobile phones and the invention is less susceptible to dust or dirt, composed of simple parts, can be easily assembled, dismantled and cleaned.

More specifically, the adaptable and adjustable pocket opening means of the mobile phone rack of the present invention includes a mainframe with a folding stand. Located into a first horizontal opening of the mainframe sidewalls are aligned and opposed rod hands which are extending perpendicular to spaced and opposed forearms and extending downward to transverse, spaced and opposed concave bodies which is a safety net and a shield for the mobile phone and still extending to transverse, spaced and opposed legs which are opposed to the forearms sleeved with tapered rubber tubes which are cushioning and diverging across the front edges to primarily contain the mobile phone. An outset of the pocket and opening is the spacing between the forearms that may be narrowed or widened, easily, by fingers for adjustment in width and the tapered tubes may be pulled or pushed, easily, for adjustment in thickness. Inserted through coupled rubber tubes are the legs having each end portion located into spaced openings below the first opening, a rubber cap sidewall cushion the back wall of the mobile phone wherein its bottom is cushioned and contained by the coupled rubber tubes which are spaced and linked to the opening adjoining with the pocket which is extending indefinitely to accommodate plugs and movement of their wires.

### BRIEF DESCRIPTION OF DRAWINGS

FIG. 1 is a perspective view of the present invention with imaginary mobile phone;

FIG. 2 is a side view of a male hanger adaptor;

FIG. 3 is a fragmentary view of the parts of an adaptable and adjustable mobile phone rack;

FIG. 4 is a view of the internal sections of a hole 101a with a collar tube 25 fitted with a leg 95;

FIG. 5 is a view of a mechanism and parts for a female cap and a male hanger adaptors;

FIG. 6 is a back view of mainframe 21 and

FIG. 7 is an internal view of the midsection of FIG. 6.

### DETAILED DESCRIPTION OF THE DRAWINGS

While the invention is susceptible of embodiment in many different forms, there is shown in the drawings and will herein, be described in detail preferred embodiments of the invention with the understanding that the present disclosure is to be considered as an exemplification of the principles of the invention and is not intended to limit the invention to the embodiments illustrated.

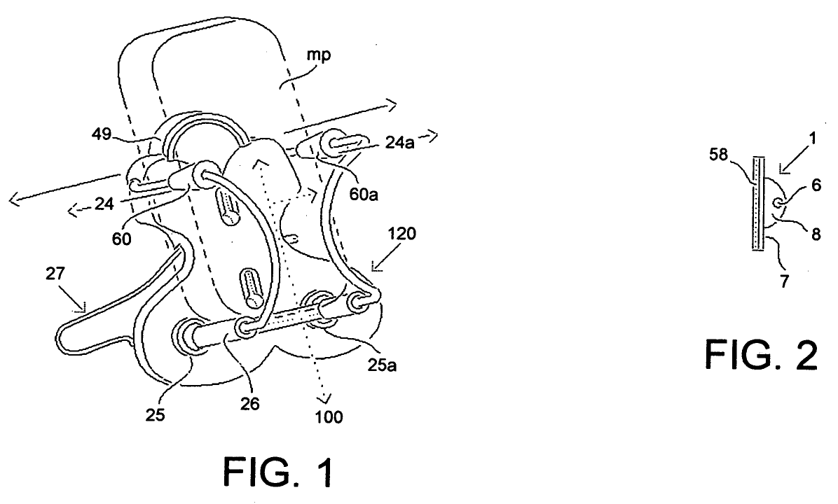

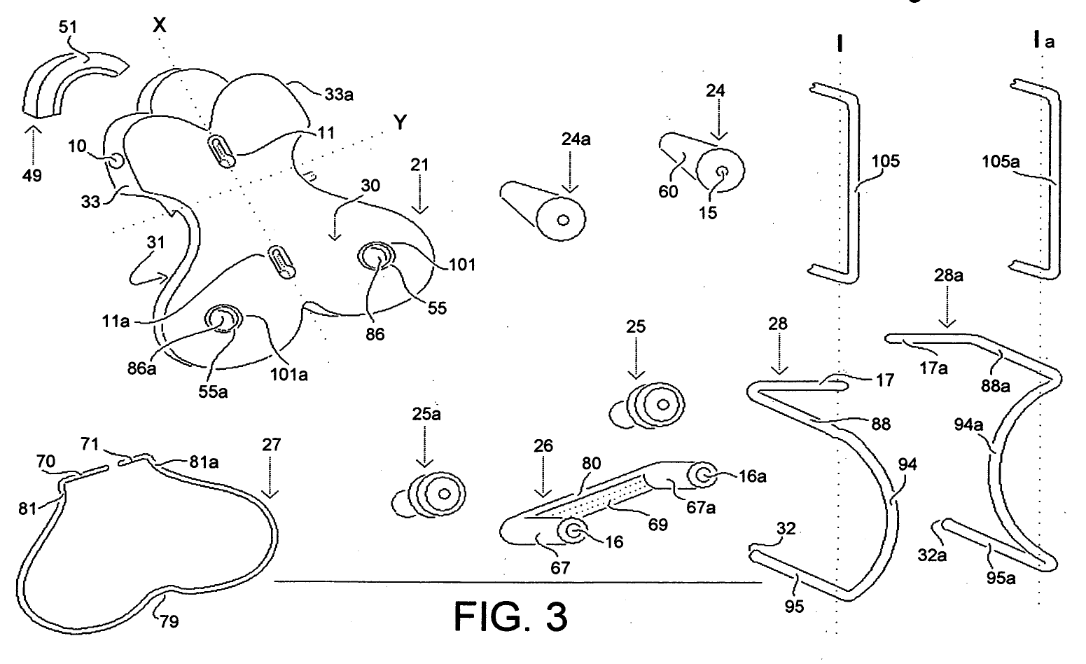

FIG. 1 of the drawing shows an adaptable and an adjustable mobile phone rack generally designated by reference numeral 120. A fragmentary view of FIG. 1 is FIG. 3 which consists of ten (10) components including mainframe 21; concave rubber cap 49; identical tapered rubber tubes 24 and 24a; identical collared rubber tubes 25 and 25a; one coupled rubber tubes 26; left pocket rod 28, right pocket rod 28a and folding rod stand 27. FIG. 5 is a mechanism and five (5) components for hanger adaptors including male hanger adaptor 1 with sticker pad 58; female cap adaptor 2; hook shaped rod 76; spring 75 and elongated circular cap nut with slotted head 99. The mobile phone is coded mp/s. Some identical parts are not numbered in the drawing, however they are designated with the suffix the same as the suffix of their section numerals.

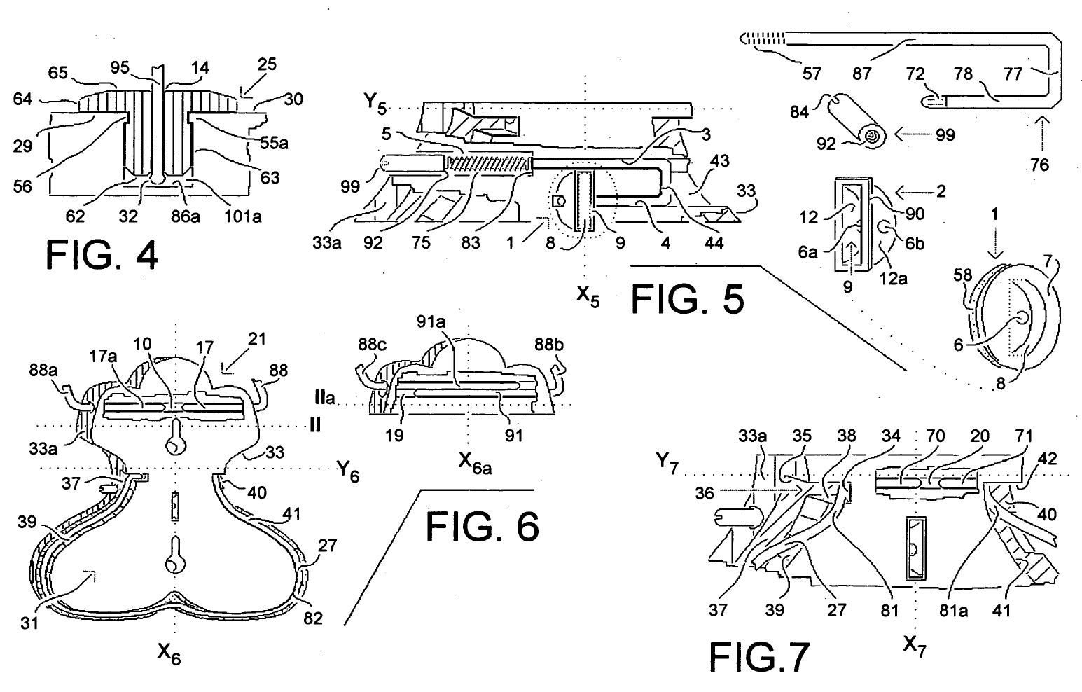

An adaptable means and an adjustable pocket adjoining or contiguous with an opening means having Mainframe 21, as illustrated in FIG. 3 which is preferably composed of a plastic, wood, rubber, glass, etc. material, mainframe 21 is substantially triangular and having a front wall 30 opposed to a back frame wall 31 and having opposed concave sidewalls 33a and 33 which are integrated to and extending between a concave top end wall and concaves bottom end wall, the top end wall is fixed with a concave rubber cap 49 wherein the latter side wall 51 is extended from the front wall 30 to cushion and confine the back wall of the mp, the mainframe 21 having each of a circular bottom wall 86 and 86a of each spaced and identical circular holes or openings 101 and 101a, each of a reduced circular sidewall 63 and 63a of each identical collared tubes 25 and 25a [FIG. 4] is fixed into each of the holes 101, 101a which are substantially perpendicular to and are disposed below a first horizontal circular opening 10, each of the collared tubes 25, 25a having a circular opening 14 and 14a, having a circular collar side wall 64 and 64a, having a circular collar wall 29 and 29a and having a circular top end wall 65 and 65a opposed to a circular bottom end wall 62 and 62a.

The frame sidewalls 33a, 33 [FIG. 3] having opposed edges of the first horizontal circular opening 10 wherein short rod hands 17 and 17a [FIG. 6 II], internal section, which are aligned and opposite towards each other are located, the short hands 17, 17a are extending both substantially perpendicular to opposed forearm rods 88 and 88a, the frame wall 30 is substantially perpendicular to the forearms 88, 88a.

The mainframe 21 sidewalls 33, 33a [FIG. 3] are configured by the bottom end wall wherein opposed concaves each facing center X meet extending up forming opposed concaves each facing opposite center X and extending up substantially parallel towards immediate downward concaves that meet at the upper X, the concave top end wall having ends which are linked to substantially centers of the downward concaves, at center X is opening 11 and spaced below is its identical opening 11a which is a circular bottom opening extending up to a narrow opening with notched outset deeper than the depths of screw heads, the mainframe 21 having the spaced circular holes 101 and 101a wherein the collared tubes 25, 25a are fixed in, fixed in the back frame is a female cap adaptor 2 [FIG. 5].

An outset of the adjustable pocket adjoining or contiguous with an opening 100 [FIGS. 1 and 3] or a spacing between the forearms 88, 88a is extending down between substantially transverse and opposed concave rod bodies 94 and 94a each facing opposite their center which is a safety net and a shield for the mp and is extending between substantially transverse and opposed rod legs 95 and 95a which are opposed to the forearms 88, 88a, each of the legs 95, 95a is located through respective circular openings 16 and 16a of a U shaped coupled rubber tubes 26 to contain and cushion various bottoms of the mp.

A portion adjacent to each identical enlarged head 32 and 32a of each of the legs 95, 95a [FIG. 4] is located through each of the circular opening 14, 14a of the collared tubes 25, 25a, heights of the legs 95, 95a while mounted and lengths of the forearms 88, 88a are increased than thickness of the various mps and the pocket 100 [FIG. 1] is of sufficient depth providing for the various mps, the adjoining opening 100 or the spacing is extending indefinitely.

Received through each of the forearms 88, 88a is each of a circular opening 15 and 15a of each identical tapered rubber tubes 24 and 24a each having an increasing outer circular surface 60 and 60a which is cushioning and is diverging across each edges to primarily confine the various mps and they are hindered to move outwards and sidewards [FIG. 1], the forearms 88, 88a may be moved, easily by fingers, to widen or narrow the spacing between each other for adjustment in width or appropriate for various widths, each of the forearms 88, 88a having a diameter greater than a diameter of each of the opening 15, 15a of each of the tapered tubes 24, 24a that may be pushed or pulled, easily, for adjustment in thickness or appropriate for various thickness.

Each of the short hands 17, 17a [FIG. 6 II] having a diameter less than a diameter of the first opening 10 to allow movement of the short hands 17, 17a, the coupled tubes 26 having a coupling opposed sidewalls 69 and top and bottom walls 80, rod stand 27 may be folded into slit 82 linked to a recess 36.

Referring to FIGS. 6 and 7, at the back frame wall 31 adjacent to Y₆ is having edges diminished by an opening or a slit 82 having an end wall 42 extending down along edges of wall 31 and up to another slit end wall 35 which is integrated to a recess sidewall, herein designated as integrated recess sidewall or slit end wall 35, the slit 82 having equidistant narrow concave slit base walls 37 and 40 which are substantially transverse to respective narrow slit side walls 39 and 41, slit end walls 35 and 42 are aligned and opposite towards each other.

As illustrated in FIG. 7, the recess 36 or opening is substantially rectangular having a base wall integrated and substantially transverse to the slit base wall, herein designated as recess or slit base wall 37, the recess 36 having opposed side walls 35 and 38 extending substantially parallel to each other from a recess end wall 34; the rod stand 27 [FIG. 3] having anchor arms 81 and 81a and having a long hinge 70 and a short hinge 71 with opposed tips, respectively, the hinges 70,71 are located into a second horizontal opening 20, the second opening 20 having opposed edges which are located in the recess end wall 34, wherein the long hinge 70 is located, and the slit sidewall 41, the opposed edges are adjacent to the respective slit end walls 35, 42 and slit base walls 37, 40.

As shown in FIG. 7, wherein anchor arm 81 of the stand 27 while shifted into the recess 36, each identical angle position of the slit base walls 37, 40 with the respective aligned slit end walls 35, 42 which abut against the respective anchor arms 81,81a, simultaneously to limit the stand 27 from lifting and the recess side wall 38 opposite the integrated recess sidewall 35 limit the anchor arm 81 or limit the stand 27 from folding, in such arrangement the stand 27 is supporting the generally upright position on the surface of the adaptable and adjustable mp rack 120 [FIG. 1].

A path of every point forming the respective concave bodies 94, 94a [FIGS. 1 and 3] is substantially perpendicular to the respective legs 95, 95a and the respective forearms 88, 88a producing a decreased spacing between the opposed concave bodies 94, 94a, the decreased spacing is less than various widths of the mp, the decreased spacing is the safety net or a secondary limit after the primary confinement of each of the increasing outer circular surface of each of the tapered 60, 60a of the tapered tubes 24, 24a.

From the coupling side wall 69 a spacing extending between tubes 67 and 67a of the coupled rubber tubes 26, the spacing between the legs 95, 95a, bodies 94, 94a and forearms 88, 88a produce the opening adjoining with the pocket 100 [FIG. 1] which is extending upwards, downwards and outwards, indefinitely to accommodate plugs and movement of their wires, the spacing between the tubes 67, 67a is of sufficient width to contain the various bottoms of the mp.

Referring to FIGS. 6 and 7, a diameter of the rod composition of the stand 27 is less than a spacing between the opposed recess side walls 35, 38 and less than a diameter of the second horizontal opening 20 to allow free shifting movement of the anchor arm 81 into the recess 36 and to allow axial movement of the hinges 70, 71, respectively; depths of the recess 36, the slit end wall 42 and the slit side walls 39, 41 are greater than the diameter of the rod composition to hide the stand 27 below the back wall 31; a dimension between internal edges of the slit 82 is less than its corresponding internal dimension between an opposed concaves form of the rod to accommodate a folding movement of stand 27 in the slit 82 and an external dimension of the opposed concaves form is less than its corresponding dimension between edges of the front wall 30 to hide stand 27 while folded behind the front wall 30.

The spaced circular openings 14, 14a and the spaced circular holes 101, 101a are disposed below the first opening 10 [FIG. 3].

A slightly modified form of the invention is illustrated in FIG. 6. In the embodiment illustrated the short rod hands 17, 17a [FIG. 6, II], internal section, are substituted for long rod hands 91 and 91a [FIG. 6, IIa], internal section, which are overlapping to each other while received into a first horizontal oval opening 19 which is a substitution for the first horizontal circular opening 10, the long hands 91, 91a are both substantially perpendicular to respective opposed forearms 88b and 88c which are identical to the forearms 88, 88a, a pocket outset which is identical to the pocket outset of the opening 100 or the spacing between the forearms 88b, 88c is increasing while the overlapping of the long hands 91, 91a is decreasing or in contrary the pocket outset is decreasing while the overlapping of the hands 91, 91a is increasing, each of rod legs which are also identical to the legs 95, 95a while each of their end portion is located into spaced circular openings which are also identical to the respective circular openings 14, 14a slightly move axially and simultaneously with the overlapping movement of the long hands 91, 91a, the oval opening 19 is having a circumference greater than a circumference of both of the overlapping long hands 91, 91a to allow the overlapping movement.

In another embodiment, opposed rod bodies 105 and 105a [FIG. 3; I and Ia] are replacements for the concave bodies 94, 94a, the spacing between the bodies 105, 105a is widened to provide an access for the fingers to the keypad while the rack 120 is gripped together with the mp.

Referring to FIG. 4, a diameter of each of the reduced circular sidewalls 63, 63a is substantially identical to a diameter of each of the spaced circular holes 101, 101a and an engagement of each of a liner 55a and 55 of each of the holes 101a, 101 against each of a groove 56 and 56a of each of the collared tubes 25, 25a while each of the collar walls 29, 29a abut against an edge of each of the holes 101a, 101 fixes each of the collared tubes 25, 25a into each of the holes 101, 101a and while the portion adjacent to the respective enlarged heads 32, 32a and each of the enlarged head 32, 32a of each of the legs 95, 95a is being force fitted down into or being disengaged from each of the spaced circular openings 14, 14a; each of the enlarged heads 32, 32a is adjacent to each of the circular bottom walls 86a, 86 while the portion adjacent to the respective enlarged heads 32, 32a is received through each of the spaced openings 14, 14a, each of the enlarged heads 32, 32a having a maximum diametric dimension less than a spacing between each of the circular bottom walls 86a, 86 and each of the circular bottom end walls 62, 62a of each of the collared tubes 25, 25a to allow slight axial movement of each of the legs 95, 95a, each of the legs 95, 95a having lesser and greater diameters than diameters of each of the enlarged heads 32, 32a and each of the spaced openings 14, 14a, respectively to contain the legs 95, 95a.

The aligned short rod hands 17, 17a may be substituted for an overlapping long rod hands 91 and 91a which are located into the first horizontal circular opening 10 and first horizontal oval opening 19 [FIG. 6, II and IIa], respectively, the first horizontal openings 10 and 19 having respective circumferential walls which are substantially perpendicular to each of a circular side wall of the spaced holes 101a, 101 and spaced holes identical to the holes 101a, 101, respectively.

Frame 21 having the spaced and identical narrow openings with notched outsets 11, 11a that may be hanged in screw heads {not in the drawing} or frame 21 may be hanged in the male hanger adaptor 1 that may be fixed with the sticker pad 58 on a side wall in cars, rooms and etc. and; includes dimensions of the frame 21, the tapered tubes 24, 24a, the forearms 88, 88a, the bodies 94, 94a and the legs 95, 95a shield the lower portion and space the upper portion of the mp from possible abutments if placed upright in a bag, pocket or the likes and still; includes a length of the adjustable pocket opening means is less than lengths of the various mps so that the latter upper portion are available for immediate grip and use and still; includes the folding stand 27 [FIG. 3] and still; includes each of the various mps while inside the pocket opening may be adapted with plugs and their wires unobstructed and still; includes the mobile phone is cushioned by being adapted only on the rubber composition of the cap side wall 51 of cap 49 [FIGS. 1 and 3], tapered tubes 24, 24a, circular top end walls 65, 65a of collared tubes 25, 25a and coupled tubes 26 which confine the back wall, sidewall edges, lower back wall and bottom, respectively of the various mps.

The frame 21 having opposed concave sidewalls each facing opposite center X [FIG. 3] which are substantially corresponding to the opposed concave bodies 94, 94a having the decreased spacing less than the width of the various mps so that the latter sidewalls are exposed to be readily and conveniently gripped together with the adaptable and adjustable rack 120.

In the frame 21 [FIG. 5] is having a third horizontal long opening 3 parallel to a fourth short opening 4 which are perpendicular and are linked to a sidewall 44 of a perpendicular and a wide opening 43 which is having an outset at the sidewall 33a of the frame 21, the third opening 3 extended to an enlarged circular base wall 83 of an enlarged fifth circular opening 5 extending through the opposite frame sidewall 33 and opposite the perpendicular opening 43.

hook shaped rod 76 [FIG. 5] is having a thread 57 at an end of a long hook 87, having an elbow 77 and having a short hook 78 with an end portion 72 and a reduced tip end, the long 87 and short 78 hooks are received into the third 3 and the fourth 4 openings, respectively; a spring 75 is received through the long hook 87 wherein an end of the spring 75 abut against the enlarged base wall 83 while an elongated circular cap nut 99 with slot 84 in its head is tightened against the thread 57 and while a base wall 92 of the cap nut 99 abut against an opposite other end of the spring 75 to produce a pulling tendency of the hook rod 76 wherein the perpendicular sidewall 44 prevent the elbow 77 or the hook rod 76 to pull beyond; a male hanger adaptor 1 is having a male hanger 8 composed of a metal sheet which is generally half circular and fixed perpendicular in a metal flange 7 with the sticker pad 58 at its bottom that may be fixed on the side wall in cars, rooms and etc., fixed in a back of the frame 21 is the female cap adaptor 2 having a generally half circular female opening 9 and having opposed walls 12 and 12a with circular openings 6a and 6b which are identical to an opening 6 of the male hanger 8.

A generally half circular dimension of the female opening 9 [FIG. 5] is substantially identical to a dimension of the half circular male hanger 8 in order to be accommodated into the female opening 9 with a sleeve 90 wherein the respective circular openings 6a, 6 and 6b are aligned with each other and; a depth of the perpendicular opening 43 is increased than a length of an exposed portion of the cap nut 99, the exposed portion has an increased length than a length of the end portion 72 of the short hook 78 which may be received into the circular openings 6 of the male hanger 8 and 6a, 6b of the female cap 2 to allow disengagement of the end portion 72 at least from the circular opening 6 of the male hanger 8 while a head of the cap nut 99 is pressed down with the finger, or release the cap nut 99 to engage the end portion 72 at most through the circular openings 6b, 6 and 6a to hang the frame 21.

The diameters of the fourth 4 and third 3 openings and the fifth 5 opening are increased than diameters of the hook shaped rod 76 and the spring 75, respectively and a width of the perpendicular opening 43 is increased than the diameter of the hook shaped rod 76 while diameters of the identical circular openings 6, 6a and 6b are increased than the end portion 72 to allow free shifting movement of the hook shaped rod 76 and the spring 75.

In the embodiment of the invention the materials for mainframe 21 is preferably composed of a wood or a fairly rigid plastic or a rubber or a glass, etc. composition while the tapered tubes 24, 24a; collared tubes 25, 25a and coupled tubes 26 are preferably composed of a flexible rubber composition and while the left pocket rod 28 and the right pocket rod 28a are preferably formed from a metal composition in circular rod form and stand 27 is preferably formed from a hard metal composition in wire or rod form. Male hanger adaptor 1 {with sticker pad 58}; female cap adaptor 2 and elongated circular cap nut 99 are preferably composed of a metal composition; hook shaped rod 76 and spring 75 are preferably composed from a hardened metal rod and wire, respectively.

In assembling the novel mobile phone rack 120, FIG. 1, each of openings 15, 15a are inserted through forearms 88, 88a passing through tips of hands 17, 17a while each increasing 60, 60a of tapered 24, 24a are increasing outward of mainframe 21. Left leg 95 and right leg 95a are inserted through openings 16, 16a of coupled tubes 26 while its coupling wall 69 is adjacent to main wall 30. Left hand 17 and right hand 17a are inserted into opening 10 to the left and right of frame 21, respectively. Insert ball end 32, 32a to openings 14, 14a while collared tubes 25, 25a are fixed into holes 101, 101a, then press down by hand the rods adjacent to bends, press down until ends of 32, 32a are at the bottom walls 86, 86a. Hands 17, 17a will not be disengaged from opening 10 without pulling out first legs 95, 95a. Long hinge 70 is inserted into opening 20 in end wall 34, stretch anchor arm 81a to insert hinge 71 into opening 20 adjacent to end wall 42.

In using the novel adaptable and adjustable mp rack, narrow down or widen with the fingers the pocket outset by moving forearms 88, 88a to arrive at a desired width, then pull or push simultaneously with the fingers the tapered rubber tubes 24, 24a until the front edges of the mp nearly touch the middle of each lengthwise surface of tapered 60, 60a of tapered tubes 24, 24a. To fold down stand 27, pull the anchor arm 81 until disengaged from an edge of sidewalls 38, 39 while holding concave walls 33a, 33 with the left thumb adjacent to recess 36 to limit anchor arm 81 and hinge 70 from disengagement, and then fold down stand 27 into slit 82. This invention may be hanged in screw heads or may be hanged in a male hanger adaptor 1 fixed with the sticker pad 58 on the side wall in cars, rooms and etc., press down cap nut 99 with fingers while engaging male hanger 8 with female opening 9 fixed in the back wall 31 of mainframe 21, when fitted release cap nut 99, or press down cap 99 to disengage male hanger 8. This invention may also stand on the surface by lifting concave coupling 79 of stand 27 or together with the mp may be placed upright in a bag, pocket or the likes while the mp is safe from possible abutments and the upper portion of the mp is available for immediate grip and use. The various mp bottoms may be plugged unobstructed together with their wires. The novel rack 120 may be conveniently gripped together with the mp.

As can be appreciated from the above description, in one embodiment, the invention 120 is having the safety net and in another embodiment the access for the fingers to the keypad is provided. In both embodiments the invention is adaptable for it, may be hanged or, may be placed upright in a bag, pocket or the likes or, it may stand on a surface or, may be plugged unobstructed together with the wires, the mp is cushioned by and adapted only on the rubber components. In both embodiments of the invention the pocket opening 100 is easily adjustable, the invention 120 is less susceptible to dust or dirt, composed of simple parts, can be easily assembled, dismantled and cleaned.

What I claimed is:

1. An adaptable rack adjustable for various sizes of mobile phones comprising;
an adaptable means and an adjustable pocket adjoining with an opening means wherein a mainframe which is substantially triangular having a front wall opposed to a back frame wall and having opposed sidewalls which are extending between a top and a bottom end walls, said top end wall is fixed with a concave rubber cap wherein the latter side wall is extended from said mainframe front wall to cushion and confine the back wall of the mobile phone, said mainframe having each of a circular bottom wall of each spaced and identical circular holes, each of a reduced circular sidewall of each identical collared tubes is fixed into each of said holes which are substantially perpendicular to and are disposed below a first horizontal circular opening, each of said collared tubes having a circular opening, having a circular collar side wall, having a circular collar wall and having opposed circular top and bottom end walls;
said frame sidewalls having opposed edges of said first horizontal circular opening wherein short rod hands which are aligned and opposite towards each other are located, said short hands are extending both substantially perpendicular to opposed forearm rods;
an outset of said adjustable pocket adjoining with said opening or a spacing between said forearms is extending down between substantially transverse and opposed concave rod bodies each facing opposite their center which is a safety net and a shield for the mobile phone and is extending between substantially transverse and opposed rod legs which are opposed to said forearms, each of said legs is located through respective circular openings of a U shaped coupled rubber tubes to contain and cushion various bottoms of the mobile phone;
a portion adjacent to each identical enlarged head of each of said legs is located through each of said circular opening of said collared tubes, heights of said legs while mounted and lengths of said forearms are increased than thickness of the various mobile phones and said pocket is of sufficient depth providing for the various mobile phones, said adjoining opening or said spacing is extending indefinitely;
located through each of said forearms is each of a circular opening of each identical tapered rubber tubes each having increasing outer circular surface which is cushioning and is diverging across each edges to primarily confine the various mobile phones and they are hindered to move outwards and sidewards;
said forearms may be moved, easily by fingers, to narrow or widen said spacing between each other for adjustment in width or appropriate for various widths, each of said forearms having a diameter greater than a diameter of each of said opening of each of said tapered tubes that may be pushed or pulled, easily, for adjustment in thickness or appropriate for various thickness, each of said short hands having a diameter less than a diameter of said first opening to allow movement of said hands, a rod stand may be folded into a slit and a recess in said back frame.

2. A mobile phone rack in accordance with claim 1 wherein said adaptable means and said adjustable pocket adjoining with said opening means comprising said mainframe sidewalls are configured by said bottom end wall wherein opposed concaves each facing a center meet extending up forming opposed concaves each facing opposite said center and extending up substantially parallel towards immediate downward concaves, said top end wall forming a concave having ends linked to substantially centers of said downward concaves, identical circular bottom openings extending up to narrow openings with notched outsets deeper than depths of screw heads are spaced into said mainframe, said mainframe having each of said spaced circular holes wherein each of said collared tubes are fixed in, fixed in said back frame is a female cap adaptor.

3. An adjustable mobile phone rack in accordance with claim 1 wherein said adaptable means comprising at said back frame wall having edges diminished by said slit having an end wall extending down along and up to another slit end wall which is integrated to a recess sidewall, said slit having narrow slit base walls which are substantially transverse to respective narrow slit sidewalls, said slit end walls are aligned and opposite towards each other;
said recess or opening is substantially rectangular having a base wall integrated and substantially transverse to said slit base wall, said recess having opposed sidewalls extending substantially parallel to each other from a recess end wall;
said stand having anchor arms and hinges, said hinges are located into a second horizontal opening, said second opening having opposed edges which are located in said recess end wall and said slit sidewall, said opposed edges are adjacent to the respective slit end walls and base walls.

4. An adjustable mobile phone rack in accordance with claim 3 wherein said adaptable means comprising said anchor arm while shifted into said recess each identical angle position of said slit base walls with the respective aligned slit end walls which abut against the respective anchor arms, simultaneously to limit said stand from lifting and said recess sidewall opposite said integrated sidewall limit said anchor arm or said stand from folding, whereby, said stand is supporting the generally upright position on the surface of said rack.

5. A mobile phone rack in accordance with claim 1 wherein said adaptable means and said adjustable pocket opening means includes a path of every point forming the respective concave bodies is substantially perpendicular to the respective legs and the respective forearms producing a decreased spacing between said concave bodies, said decreased spacing is less than various widths of the mobile phones, said decreased spacing is said safety net or a secondary limit.

6. A mobile phone rack in accordance with claim 1 wherein said adaptable means and said adjustable pocket opening means comprising from a coupling sidewall a spacing extending between said coupled tubes, said spacing between said legs, bodies and forearms produce said opening adjoining with said pocket which is extending upwards, downwards and outwards, indefinitely to accommodate plugs and movement of their wires, said spacing between said tubes is of sufficient width to contain the various bottoms.

7. An adjustable mobile phone rack in accordance with claim 3 wherein said adaptable means comprising a diameter of a rod composition of said stand is less than a spacing between said opposed recess sidewalls and less than a diameter of said second opening to allow free shifting movement of said anchor arm into said recess and to allow axial movement of said hinges, respectively;
depths of said recess, said slit end wall and said slit side walls are greater than the diameter of the rod composition to hide said stand below said back wall;
a dimension between internal edges of said slit is less than its corresponding internal dimension between an opposed form of the rod to accommodate a folding movement of said stand into said slit and an external dimension of said opposed form is less than its corresponding dimension between edges of a front wall to hide said stand while folded behind said front wall.

8. A mobile phone rack in accordance with claim 1 wherein said adaptable means and said adjustable pocket opening means comprising said spaced circular openings and said spaced circular holes are disposed below said first horizontal opening.

9. A mobile phone rack in accordance with claim 1 wherein said adaptable means and said adjustable pocket opening means comprising said short hands are substituted for long rod hands which are overlapping to each other while located into a first horizontal oval opening, a pocket outset or a spacing between forearms is increasing while the overlapping of said long hands is decreasing or, in contrary, said spacing is decreasing while the overlapping of said long hands is increasing, each of legs while each of their end portion is located into spaced circular openings slightly move axially and simultaneously with the overlapping movement, said oval opening is having a circumference greater than a circumference of both of said overlapping hands to allow the overlapping movement.

10. An adjustable mobile phone rack in accordance with claim 5 wherein said adaptable means includes opposed rod bodies which are replacements for said concave bodies, said spacing between said bodies is widened to provide an access for fingers to the keypad while said rack is gripped together with the mobile phone.

11. A mobile phone rack in accordance with claim 1 wherein said adaptable means and said adjustable pocket opening means includes a diameter of each of said reduced circular sidewalls is substantially identical to a diameter of each of said holes and an engagement of each of a liner of each of said holes against each of a groove of each of said collared tubes while each of said collar walls abut against an edge of each of said holes fixes each of said collared tubes into each of said holes and while said portion adjacent to the respective enlarged heads and each of said enlarged heads is being force fitted down into or being disengaged from each of said spaced openings;
each of said enlarged heads is adjacent to each of said circular bottom walls while said portion adjacent the respective enlarged heads is located through each of said spaced openings, each of said enlarged heads having a maximum diametric dimension less than a spacing between each of said circular bottom walls and each of said circular bottom end walls to allow slight axial movement of each of said legs, each of said legs having lesser and greater diameters than diameters of each of said enlarged heads and each of said spaced openings, respectively to contain said legs.

12. A mobile phone rack in accordance with claim 1 wherein said adaptable means and said adjustable pocket opening means comprising said aligned hands and an overlapping hands are located into respective first openings, said first openings having respective circumferential walls which are substantially perpendicular to each of a circular side wall of said spaced holes and their identical spaced holes, respectively.

13. An adjustable mobile phone rack in accordance with claim 1, wherein said adaptable means includes said frame having spaced and identical narrow openings with notched outsets that may be hanged in screw heads or said frame may be hanged in a hanger adaptor that may be fixed with a sticker pad on a side wall in cars, rooms and etc. and;
includes dimensions of said frame, said tapered tubes, said forearms, said bodies and said legs shield the lower portion and space the upper portion of the mobile phone from possible abutments if placed upright in a bag, pocket or the likes and still;
includes a length of said adjustable pocket opening means is less than lengths of the various mobile phones so that the latter upper portion are available for immediate grip and use and still;
includes said folding stand and still;
includes each of the various mobile phones while inside said pocket opening may be adapted with plugs and their wires unobstructed and still;
includes the mobile phone is cushioned by being adapted only on the rubber composition of said cap side wall, tapered tubes, circular top end walls and coupled rubber tubes which confine the back wall, sidewall edges, lower back wall and bottom, respectively of the various mobile phones.

14. An adjustable mobile phone rack in accordance with claim 5, wherein said adaptable means comprising a frame having opposed concave sidewalls each facing opposite their center which are substantially corresponding to said opposed concave bodies having said decreased spacing less than the width of the various mobile phones so that the latter sidewalls are exposed to be readily and conveniently gripped together with said adaptable and adjustable rack.

15. An adjustable mobile phone rack in accordance with claim 1 wherein said adaptable means comprising in said frame is having a third horizontal long opening parallel to a fourth short opening which are perpendicular and are linked to a perpendicular sidewall of a perpendicular and wide opening which is having an outset at said sidewall of said frame, said third opening extended to an enlarged circular base wall of an enlarged fifth circular opening extending through said frame opposite side wall and opposite said perpendicular opening.

16. An adjustable mobile phone rack in accordance with claim 15 wherein said adaptable means comprising a hook shaped rod is having a thread at an end of a long hook, having an elbow and having a short hook with an end portion and a reduced tip end, said long and short hooks are located into said third and said fourth openings, respectively;
a spring is located through said long hook wherein an end of said spring abut against said enlarged base wall while an elongated circular cap nut is tightened against said thread and while a base wall of said cap nut abut against an opposite other end of said spring to produce a pulling tendency of said hook rod wherein said perpendicular sidewall prevent said elbow or said hook rod to pull beyond;
a male hanger adaptor is having a male hanger composed of a metal sheet which is generally half circular and fixed perpendicular in a metal flange with a sticker pad at its bottom that may be fixed on a side wall in cars, rooms and etc., fixed in a back of said frame is a female cap adaptor having a generally half circular female opening and having opposed walls with circular openings which are identical to an opening of said male hanger.

17. An adjustable mobile phone rack in accordance with claim 16 wherein said adaptable means comprising a generally half circular dimension of said female opening is substantially identical to a dimension of said half circular male hanger in order to be accommodated into said female opening wherein the respective circular openings are aligned with each other and;
a depth of a perpendicular opening is increased than a length of an exposed portion of said cap nut, said exposed portion has an increased length than a length of said end portion which may be located into said circular openings to allow disengagement of said end portion at least from said circular opening of said male hanger while a head of said cap nut is pressed down with the finger, or release said cap nut to engage said end portion at most through said circular openings to hang said frame.

18. In an adaptable rack adjustable for various mobile phones comprising a mainframe having a front wall opposed to a back wall having opposed sidewalls extending between a bottom and a top end walls, located in said mainframe is a first horizontal opening wherein rod hands are located, said hands are extending both substantially perpendicular to spaced forearms and are extending down to spaced bodies and still are extending to substantially transverse and spaced legs which are opposed to said forearms;
each of said forearms is located through each of an opening of tapered tubes having increasing outer surfaces which are diverging across edges to contain the mobile phone, said forearms may be moved, easily by fingers, and said tapered tubes may be pushed or pulled, easily, appropriate for various widths and thickness, respectively;
each of said legs having rubber tubes to contain various bottoms, an end portion of each of said legs is located in each of spaced openings which are substantially perpendicular to and below said first opening, said frame having spaced narrow openings with notched outsets and a folding stand.
